(19) United States
(12) Patent Application Publication
(10) Pub. No.: US 2026/0084757 A1
(43) Pub. Date: Mar. 26, 2026

(54) VEHICLE LOWER BODY STRUCTURE

(71) Applicant: MAZDA MOTOR CORPORATION, Hiroshima (JP)

(72) Inventors: Harumitsu KUBOTA, Aki-gun (JP); Morihide YAMADA, Aki-gun (JP); Takuya SAEKI, Aki-gun (JP)

(73) Assignee: MAZDA MOTOR CORPORATION, Hiroshima (JP)

(21) Appl. No.: 19/302,435

(22) Filed: Aug. 18, 2025

(30) Foreign Application Priority Data
Sep. 20, 2024 (JP) 2024-163859

(51) Int. Cl. B62D 25/20; B60K 1/04; B62D 25/02

(52) U.S. Cl. CPC B62D 25/20; B60K 1/04; B62D 25/025; B60K 2001/0438

(57) ABSTRACT

A vehicle lower body structure which efficiently transmits a side collision load from one side sill to the other side sill includes a pair of left and right side sills extending in a vehicle front-rear direction at opposed lateral ends of a front floor panel in a vehicle width direction; and plural floor cross members coupling the pair of left and right side sills in the vehicle width direction and fixed to an upper surface of the front floor panel. The floor cross members include a front cross member on a vehicle front side; a rear cross member on a vehicle rear side at a predetermined interval from the front cross member; and an intermediate cross member between the front cross member and the rear cross member in the vehicle front-rear direction and fixed to each of the front cross member and the rear cross member.

### TECHNICAL FIELD

The present disclosure relates to a vehicle lower body structure including a cross member that couples a pair of left and right side sills provided on opposing end sides in a vehicle width direction to each other in the vehicle width direction.

### BACKGROUND

Some vehicles such as automobiles are provided with a cross member on a floor panel to suppress deformation of a cabin that is caused by a collision load from a vehicle lateral side, the cross member coupling a pair of left and right side sills provided on both end sides in a vehicle width direction. As a result, a side collision load, which is a collision load from the vehicle lateral side, can be transmitted from one of the side sills to the other side sill via the cross member.

For example, in JP2023-080379A, the plural cross members, each of which couples the pair of left and right side sills in the vehicle width direction, are fixed to an upper surface of the floor panel, and the side collision load can be transmitted via the plural cross members. In this way, the side collision load can be dispersed and transmitted from the one side sill to the other side sill.

In order to efficiently transmit the side collision load, which is applied from the vehicle lateral side, from the one side sill to the other side sill, it is conceivable to improve the rigidity of the cross member. However, improvement in the rigidity of the cross member causes such a problem that a cross section of the cross member is enlarged, which weighs on a space in the cabin or increases weight. Accordingly, there is a demand for a vehicle lower body structure capable of efficiently transmitting the side collision load from the one side sill to the other side sill.

### SUMMARY

The disclosure provides a vehicle lower body structure capable of efficiently transmitting a side collision load from one side sill to the other side sill.

The disclosure is a vehicle lower body structure including: a pair of left and right side sills that extend in a vehicle front-rear direction at opposing lateral ends of a floor panel in a vehicle width direction; and plural cross members, each of which couples the pair of left and right side sills in the vehicle width direction and is fixed to an upper surface of the floor panel.

The cross members include: a first cross member that is provided on a vehicle front side; a second cross member that is provided on a vehicle rear side at a predetermined interval from the first cross member; and a third cross member that is provided between the first cross member and the second cross member in the vehicle front-rear direction and is fixed to each of the first cross member and the second cross member.

The cross members include a cross member having an open cross-sectional shape that forms a closed cross section with the floor panel, a cross member having a closed cross-sectional shape such as a cylindrical body, and the like. The side sill and the cross member may be coupled by directly connecting both end portions of the cross member and the side sill, or may be coupled via a seat attachment bracket or a gusset provided to both end portions of the cross member.

According to the disclosure, a side collision load can efficiently be transmitted from one side sill to the other side sill. More specifically, the first cross member, the second cross member, and the third cross member are provided to couple the pair of left and right side sills, which extend in the vehicle front-rear direction at both lateral ends of the floor panel, in the vehicle width direction and are fixed to the upper surface of the floor panel. Then, the third cross member is fixed to each of the first cross member and the second cross member. Accordingly, in cooperation with the front floor panel, the first cross member, the second cross member, and the third cross member, which are fixed to each other, can improve the rigidity of a body against a side collision load as a collision load from a vehicle lateral side. Therefore, in the vehicle lower body structure, the side collision load, which is generated when a narrow collision object such as a utility pole collides with the vehicle lateral side, can efficiently be transmitted from the one side sill to the other side sill.

As described above, in the vehicle lower body structure, the first cross member, the second cross member, the third cross member, which is fixed to each of the first cross member and the second cross member, and the floor panel can cooperatively improve the rigidity of the body and efficiently transmit the side collision load from the one side sill to the other side sill. Therefore, the vehicle lower body structure can suppress deformation of the side sill, the cross member, the floor panel, and the like caused by the side collision load, which is generated when the narrow collision object collides with the vehicle lateral side.

In an aspect of the disclosure, the first cross member may be provided with a front attachment section for attaching a front side of a front seat in a vehicle, and the second cross member may be provided with a rear attachment section for attaching a rear side of the front seat.

According to the disclosure, in the vehicle lower body structure, at a position near a position of a center of gravity in the vehicle, the side collision load can efficiently be transmitted from the one side sill to the other side sill. More specifically, in general, the position of the center of gravity in the vehicle is frequently set at a position near the front seat in the vehicle front-rear direction. Between the first cross member and the second cross member, the third cross member, which is fixed thereto, is arranged. The first cross member is provided with the front attachment section for attaching the front side of the front seat at the position near the position of the center of gravity in the vehicle in the vehicle front-rear direction as described above. The second cross member is provided with the rear attachment section for attaching the rear side of the front seat. In this way, the vehicle lower body structure can improve the rigidity of the body at the position near the position of the center of gravity in the vehicle. Thus, at the position near the position of the center of gravity in the vehicle, it is possible to efficiently transmit the side collision load from the one side sill to the other side sill.

More specifically, in the case where the narrow collision object collides with the vehicle lateral side, which deviates from the position of the center of gravity of the vehicle, the body rotates about the center of gravity of the vehicle as a rotation center. Thus, the side collision load can be dispersed. Meanwhile, in the case where the narrow collision object collides with the vehicle lateral side toward the position of the center of gravity of the vehicle, the side collision load is concentrically applied to the body without being dispersed.

In the vehicle lower body structure, as described above, between the first cross member provided with the front attachment section for attaching the front side of the front seat and the second cross member provided with the rear attachment section for attaching the rear side of the front seat, the third cross member is fixed to the first cross member and the second cross member and is fixed to the floor panel. Therefore, the third cross member arranged below the front seat can improve the rigidity at the position near the position of the center of gravity in the vehicle. In this way, even when the narrow collision object collides with the vehicle lateral side toward the position of the center of gravity of the vehicle, the side collision load, which is concentrically applied to the body, can efficiently be transmitted from the one side sill to the other side sill.

In addition, in the vehicle lower body structure, between the first cross member and the second cross member in the vehicle front-rear direction, the third cross member, which is fixed thereto, is arranged on the lower side of the front seat. Thus, it is possible to secure space in a foot portion of the front seat even when the third cross member is provided.

In addition, as an aspect of the disclosure, the cross member may be formed to have a substantially M-shaped cross section extending in the vehicle width direction. According to the disclosure, it is possible to improve the rigidity of each of the cross members when compared to a cross member having a hat-shaped cross section. Thus, the vehicle lower body structure can efficiently transmit the side collision load from the one side sill to the other side sill.

In the aspect of the disclosure, a tunnel section that protrudes upward may be formed in a central position of the floor panel in the vehicle width direction, and the cross members may each couple the pair of left and right side sills in the vehicle width direction across the tunnel section.

According to the disclosure, the cross member that is provided across the tunnel section extending in the vehicle front-rear direction at the central position in the vehicle width direction is coupled to the pair of left and right side sills in the vehicle width direction. Therefore, the vehicle lower body structure can reliably transmit the side collision load from the one side sill to the other side sill when compared to a pair of cross members coupling the pair of left and right side sills with the tunnel section being interposed therebetween.

As an aspect of the disclosure, the tunnel section may have a side wall portion opposed to the vehicle width direction, the cross member may include a front flange section extending forward in the vehicle and a rear flange section extending rearward in the vehicle, and the front flange section and the rear flange section are joined to the side wall portion.

According to the disclosure, since the cross member can form the closed cross section also in the side wall portion of the tunnel section, it is possible to improve the rigidity of the tunnel section and to improve the rigidity of the cross member provided across the tunnel section. Therefore, in the vehicle lower body structure, the deformation of the tunnel section can be suppressed, and the side collision load can efficiently be transmitted from the one side sill to the other side sill across the tunnel section.

In an aspect of the disclosure, the rear flange section of the first cross member may fixedly be superimposed on the front flange section of the third cross member, and the rear flange section of the third cross member may fixedly be superimposed on the front flange section of the second cross member.

According to the disclosure, since the first cross member, the second cross member, and the third cross member can easily be attached to the floor panel, it is possible to improve the efficiency of the fixing work to fix the cross member to the floor panel.

In addition, in the case where the first cross member and the second cross member are provided with the front attachment section and the rear attachment section for attaching the front seat in the vehicle, the downward displacement of the front seat can be suppressed. More specifically, the first cross member can be supported by the third cross member, and the third cross member can be supported by the second cross member. Thus, it is possible to restrict the downward displacement of the cross member, which is associated with the upward displacement of the tunnel section by the side collision load. Therefore, in the vehicle lower body structure, when the front attachment section and the rear attachment section for attaching the front seat in the vehicle are provided to the first cross member and the second cross member, the downward displacement of the front seat can be suppressed.

In an aspect of the disclosure, the side sill and the cross member may be joined to each other such that positions of an upper surface of the side sill and an upper surface of the cross member are aligned in the vehicle up-down direction. That the side sill and the cross member described above are joined to align the positions of the side sill upper surface and the cross member upper surface in the vehicle up-down direction may be joining to align the upper surface of the side sill and the upper surface of the cross member in the vehicle width direction or may be joining to make the upper surface of the cross member partially overlap the upper surface of the side sill. Further, in the case where the upper surface of the side sill is an inclined surface inclined in the vehicle up-down direction with respect to the vehicle width direction, it means that the upper surface of the cross member is joined to be arranged within a range from an upper end position to a lower end position of the upper surface of the inclined side sill in the vehicle up-down direction.

According to the disclosure, the ridgeline sections, the rigidity of which is higher than that of the other portions in the side sill and the cross member have the extending directions that are substantially orthogonal to each other in the plan view, but are located at substantially the same positions in the vehicle up-down direction. That is, the ridgeline section of the floor cross member and the ridgeline section of the side sill are continuous. Therefore, the vehicle lower body structure can efficiently transmit the side collision load from the one side sill to the other side sill. The ridgeline section, which extends in the vehicle front-rear direction and forms the side sill upper surface in the side sill, and the ridgeline section, which extends in the vehicle width direction and forms the cross member upper surface in the cross member, have higher rigidity than the other portions in the respective members.

As an aspect of the disclosure, a battery unit may be provided below the floor panel, and a coupling section may be provided for coupling the cross member and the battery unit to each other by fastening a fastening member inserted from an upper surface of the cross member superimposed on the tunnel section.

According to the disclosure, in the central portion in the vehicle width direction, the upward displacement of the cross member and the tunnel section by the side collision load is suppressed by the battery unit coupled via the fastening member and the coupling section. Therefore, the vehicle lower body structure can reliably transmit the side collision load from the one side sill to the other side sill.

As an aspect of the disclosure, the upper surface of the cross member may be provided with a recessed groove recessed downward and extending in the vehicle width direction, and a length of the recessed groove in the tunnel section in the vehicle front-rear direction may be longer than a length of the recessed groove in the vehicle front-rear direction in another portion.

According to the disclosure, a seat surface for fixing the cross member and the battery unit can be secured, and the rigidity of the cross member can be improved. Therefore, the vehicle lower body structure can reliably fix the cross member and the battery unit, and can further suppress the upward displacement and the deformation of the cross member.

According to the disclosure, it is possible to provide the vehicle lower body structure capable of efficiently transmitting the side collision load from the one side sill to the other side sill.

### BRIEF DESCRIPTION OF THE DRAWINGS

FIG. 1 is an external perspective view illustrating external appearance of a vehicle lower body that is viewed from the front of a vehicle.

FIG. 2 is a plan view illustrating the external appearance of the vehicle lower body in a plan view.

FIG. 3 is an external perspective view illustrating external appearance of a main section of the vehicle lower body that is viewed from the rear of the vehicle.

FIG. 4 is a cross-sectional view that is taken along an arrow A-A in FIG. 2.

FIG. 5 is a cross-sectional view that is taken along an arrow C-C in FIG. 2.

FIG. 6 is an enlarged cross-sectional view of a main section in FIG. 5.

FIG. 7 is a cross-sectional view that is taken along an arrow B-B in FIG. 2.

### DETAILED DESCRIPTION

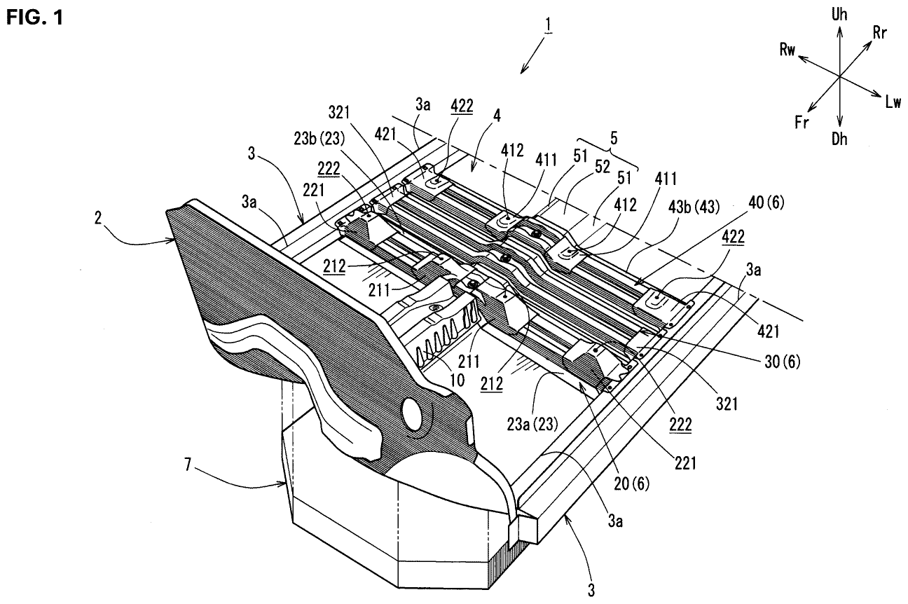

An embodiment of the disclosure will be described below with reference to the drawings. For example, a vehicle 1 according to this embodiment is an electric vehicle in which, substantially at a center of the front floor panel 4 in a vehicle front-rear direction, a floor cross member 6 is provided to couple a pair of left and right side sills 3 in a vehicle width direction. A detailed description will be made on a lower body structure in a cabin portion of such a vehicle 1 with reference to FIG. 1 to FIG. 7.

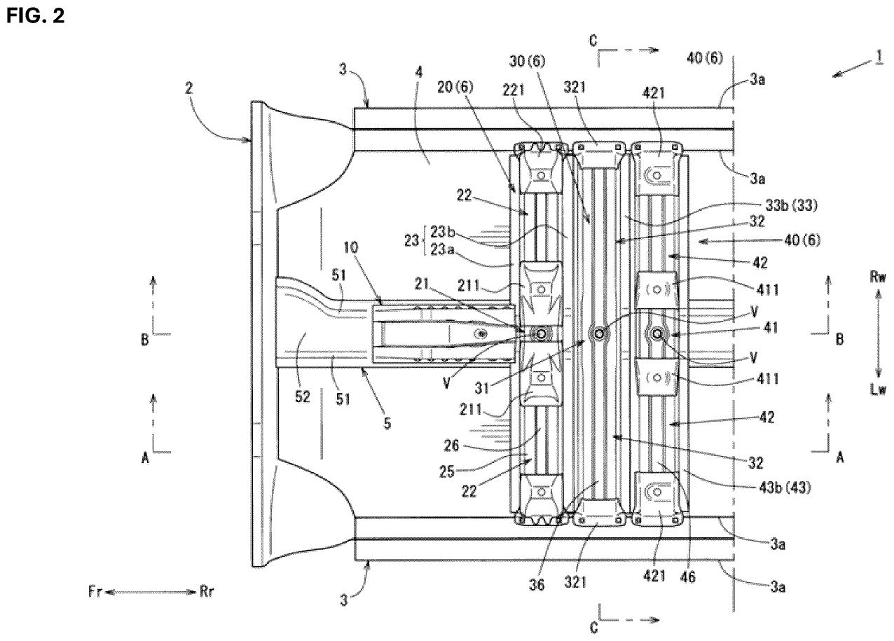

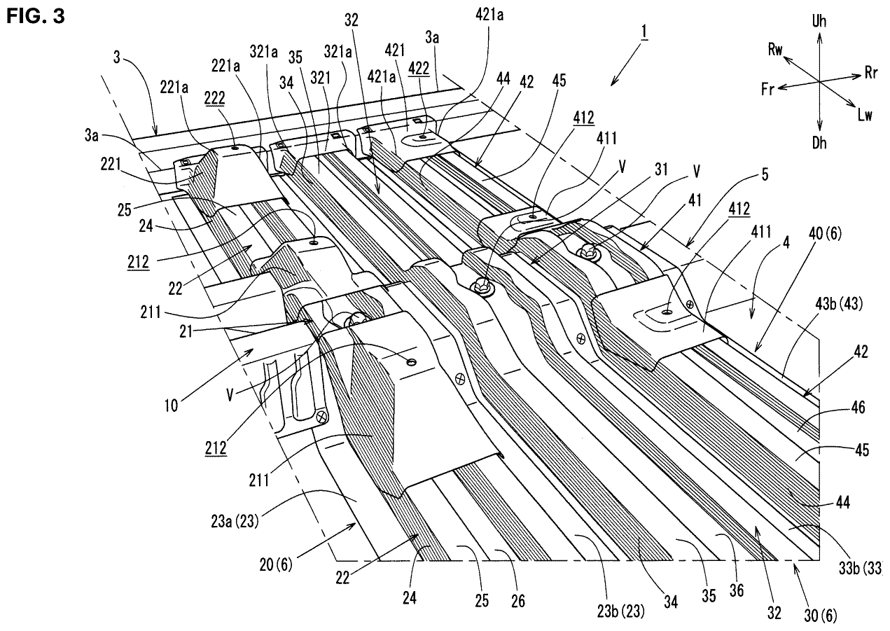

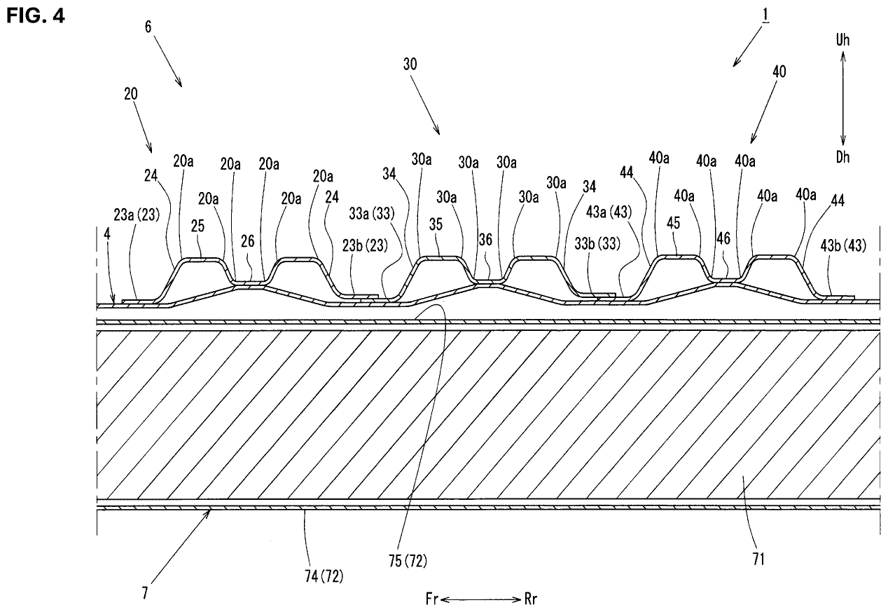

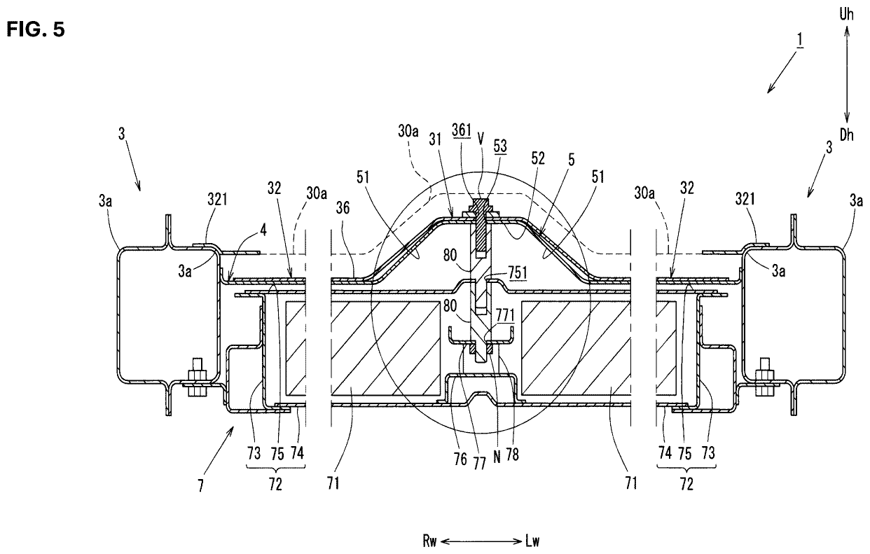

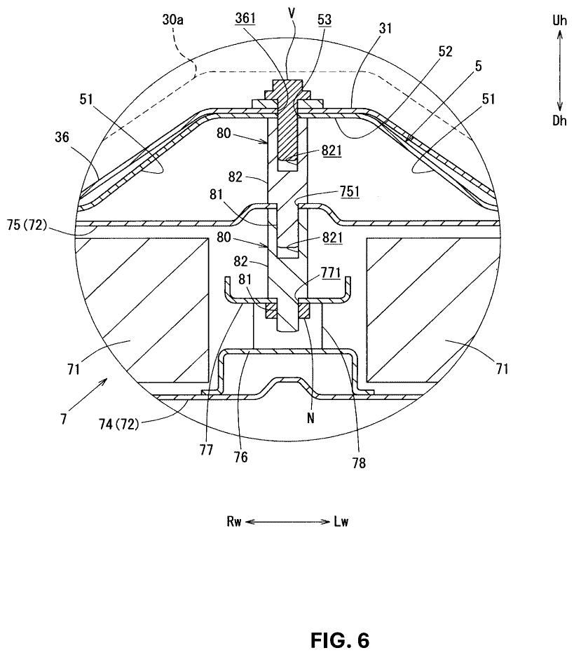

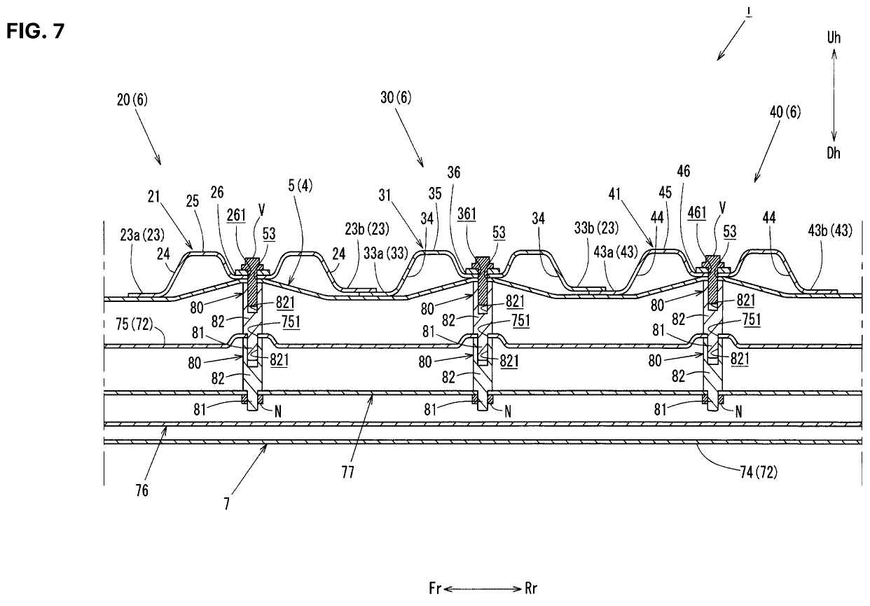

FIG. 1 is an external perspective view of a lower body of the vehicle 1 that is viewed from the front of the vehicle, FIG. 2 is a plan view of the lower body of the vehicle 1, and FIG. 3 is an external perspective view illustrating external appearance of a main section in the lower body of the vehicle 1 that is viewed from the rear of the vehicle. FIG. 4 is a cross-sectional view that is taken along an arrow A-A in FIG. 2, FIG. 5 is a cross-sectional view that is taken along an arrow C-C in FIG. 2, FIG. 6 is an enlarged cross-sectional view of a main section that is surrounded by a circle in FIG. 5, and FIG. 7 is a cross-sectional view of a main section that is taken along an arrow B-B in FIG. 2.

In the drawings, arrows Fr and Rr indicate the front-rear direction, an arrow Fr indicates a front direction, and an arrow Rr indicates a rear direction. Arrows Rw and Lw indicate the vehicle width direction, an arrow Rw indicates a right direction, and an arrow Lw indicates a left direction. Furthermore, arrows Uh and Dh indicate a vehicle up-down direction, an arrow Uh indicates a vehicle up direction, and an arrow Dh indicates a vehicle down direction.

As illustrated in FIGS. 1 and 2, the lower body of the vehicle 1 includes: a dashboard 2 that separates an engine room and the cabin in the vehicle front-rear direction; a pair of left and right side sills 3 that extend rearward in the vehicle from lower portions at both ends of the dashboard 2 in the vehicle width direction; and the front floor panel 4 that is disposed between the left and right side sills 3 and forms a cabin floor surface.

As illustrated in FIGS. 1, 2, and 3, the front floor panel 4 is formed with a tunnel section 5 near a substantial center in the vehicle width direction, the tunnel section 5 bulging in the vehicle up direction in a substantially tunnel shape and extending from the front of the vehicle toward the rear of the vehicle. In addition, in the lower body of the vehicle 1, at a position near the center of the front floor panel 4 in the vehicle front-rear direction, the floor cross member 6 that couples the pair of left and right side sills 3 in the vehicle width direction across the tunnel section 5 is fixed to an upper surface of the front floor panel 4. Furthermore, a battery unit 7 coupled to a highly rigid portion of the body is disposed below the front floor panel 4.

More specifically, the dashboard 2 is a panel member that is thick in the vehicle front-rear direction, and is formed in such a shape that a lower portion thereof is curved rearward in the vehicle. From a lower end of this dashboard 2, the front floor panel 4 is provided to extend rearward in the vehicle.

The side sills 3 are provided as the left and right pair that extends rearward in the vehicle from the lower portions at both ends of the dashboard 2 in the vehicle width direction, and are each configured to have a substantially rectangular closed cross section. That is, at corners of an upper surface portion of the side sill 3, ridgeline sections 3a, each of which extends in the vehicle front-rear direction, are formed at predetermined intervals in the vehicle width direction.

As illustrated in FIGS. 2 and 4, the front floor panel 4 is a panel member that is thick in the vehicle up-down direction. A front end thereof is coupled to the lower end of the dashboard 2, and both end portions in the vehicle width direction are joined to the respective side sills 3. Then, at the substantial center of the front floor panel 4 in the vehicle width direction, as described above, the tunnel section 5 is formed to protrude in the vehicle up direction.

As illustrated in FIGS. 3 and 4, the tunnel section 5 is formed to have a substantially hat-shaped cross section that protrudes in the vehicle up direction, and extends from the front end to a rear end of the front floor panel 4 in the vehicle front-rear direction. An end portion on the vehicle front side in the tunnel section 5 is joined to the dashboard 2. The front end portion of the tunnel section 5 is covered with a console bracket 10.

More specifically, as illustrated in FIGS. 3 and 5, the tunnel section 5 includes: a pair of left and right side wall portions 51 that are erected upward from the front floor panel 4 while being inclined toward the center in the vehicle width direction; and a tunnel upper portion 52 that has a substantially planar shape and couples upper end portions of the pair of left and right side wall portions 51. Here, the height of the side wall portion 51 from the front floor panel 4 is slightly greater than the height of the side sill 3 from the front floor panel 4.

On a vehicle front side of a front cross member 20, which will be described below, the tunnel upper portion 52 is inclined downward in the vehicle in the vehicle rear direction, and, on a vehicle rear side of the front cross member 20, extends substantially horizontally along the vehicle front-rear direction. As illustrated in FIGS. 5 and 6, in a central portion of the thus-configured tunnel upper portion 52 in the vehicle width direction, plural through holes 53 penetrating in the vehicle up-down direction are provided at predetermined intervals in the vehicle front-rear direction.

As illustrated in FIG. 2, the floor cross member 6 includes the front cross member 20, an intermediate cross member 30, and a rear cross member 40, each of which couples the left and right side sills 3 in the vehicle width direction, is fixed to the upper surface of the front floor panel 4, and has a substantially M-shaped cross section.

As illustrated in FIGS. 2, 3, and 4, the front cross member 20, the intermediate cross member 30, and the rear cross member 40 are arranged in this order from the vehicle front side toward the vehicle rear side while coupling the pair of left and right side sills 3 in the vehicle width direction across the tunnel section 5 that extends in the vehicle front-rear direction. That is, at positions near the center of the front floor panel 4 in the vehicle front-rear direction, the front cross member 20, the intermediate cross member 30, and the rear cross member 40 couple the pair of left and right side sills 3 substantially linearly in a plan view.

As illustrated in FIGS. 2 and 3, the front cross member 20 is arranged on the vehicle front side of the intermediate cross member 30, and is provided to extend in the vehicle width direction across the tunnel section 5. More specifically, the front cross member 20 includes: a crossing section 21 crossing the tunnel section 5 in a central portion in the vehicle width direction; and a pair of left and right member bodies 22, each of which extends in the vehicle width direction, between outer end portions of the crossing sections 21 in the vehicle width direction and the respective side sills 3.

As illustrated in FIGS. 2 and 3, the crossing section 21 is formed to bulge in the vehicle up direction along the tunnel section 5 when compared to the member bodies 22. In each outer portion of the crossing section 21 in the vehicle width direction, a front inner seat bracket 211 for attaching a front seat (not illustrated) is provided in a manner to extend across a boundary portion with the respective member body 22.

As illustrated in FIGS. 2 and 3, the front inner seat bracket 211 has a substantially box shape in which a central portion in the vehicle width direction is formed in a substantial chevron shape protruding upward, and an outer side in the vehicle width direction and a vehicle lower side of which are opened, and a vertical cross-sectional shape along the vehicle width direction is a closed cross-sectional shape formed by the front floor panel 4 and the tunnel section 5. An upper end surface of the thus-configured front inner seat bracket 211 is set above the tunnel upper portion 52, and has a front inner attachment hole 212 for attaching a vehicle front side of the front seat. The front inner seat bracket 211, the tunnel section 5, and the front cross member 20 are fixed to each other when being joined by welding such as spot welding.

As illustrated in FIG. 2, the member bodies 22 each extend in the vehicle width direction continuously from the respective outer end portion of the crossing section 21 in the vehicle width direction, and are respectively joined to the pair of left and right side sills 3 via the front outer seat brackets 221 that are provided in both end portions in the vehicle width direction.

The front outer seat bracket 221 and the front inner seat bracket 211 have substantially bilaterally symmetrical shapes. More specifically, the front outer seat bracket 221 has a substantially box shape in which a central portion in the vehicle width direction is formed in a substantial chevron shape protruding upward, and an outer side in the vehicle width direction and a vehicle lower side of which are opened, and a vertical cross-sectional shape along the vehicle front-rear direction has a closed cross section that is formed by the side sill 3 and the member body 22. The front outer seat bracket 221 in such a shape has a ridgeline section 221a in an upper portion.

In addition, an upper surface on the vehicle outer side of the front outer seat bracket 221 is joined to the side sill 3, while an upper surface on the vehicle inner side of the front outer seat bracket 221 is fixed to a coupling section 25, which will be described below, by welding such as spot welding. The front outer seat bracket 221, which couples the side sill 3 and the coupling section 25, is set at a higher position than the side sill 3, and has a front outer attachment hole 222 for attaching the vehicle front side of the front seat in an upper end surface.

As illustrated in FIG. 4, the front cross member 20, which couples the side sills 3 while extending across the tunnel section 5 along the tunnel section 5 as described above, is provided with a pair of flange sections 23 extending in the vehicle front-rear direction along the vehicle width direction on both sides in the vehicle front-rear direction. The flange section 23 and the front floor panel 4 are joined by welding such as spot welding. As a result, the front cross member 20 forms a closed cross section with the front floor panel 4.

In the crossing section 21, both end portions of the flange section 23 in the vehicle width direction are inclined along the pair of left and right side wall portions 51. In the crossing section 21, a central portion of the flange section 23 in the vehicle width direction is substantially horizontal along the tunnel upper portion 52 (see FIG. 5). The flange section 23 provided in the crossing section 21, which protrudes in the vehicle up direction, as described above is fixed when being joined to the tunnel section 5, which constitutes the front floor panel 4, by spot welding or the like. Here, of the pair of flange sections 23 that extend in the vehicle front-rear direction, the flange section 23 on the vehicle front side is defined as a front flange section 23a, and the flange section 23 on the vehicle rear side is defined as a rear flange section 23b.

As illustrated in FIG. 4, in a vertical cross section along the vehicle front-rear direction, such a front cross member 20 is formed to have the substantially M-shaped cross section. More specifically, on inner end portions of the flange sections 23 in the vehicle front-rear direction in the front cross member 20, the front cross member 20 has: a pair of front and rear erected sections 24, each of which is inclined toward the other of the paired flange sections 23 while extending in the vehicle up direction; and the coupling section 25 that couples upper ends of the erected sections 24 from one end to the other end in the vehicle width direction.

The coupling section 25 is set such that a position of an upper surface thereof is aligned with a position of the upper surface of the side sill 3 in the vehicle up-down direction, and is joined to the side sill 3 via the front outer seat bracket 221. That is, the side sill 3 and the coupling section 25 are coupled by the front outer seat bracket 221.

In addition, as illustrated in FIGS. 2 and 4, in a central portion of the coupling section 25 in the vehicle front-rear direction, a recessed groove 26 is provided to extend from one end to the other end of the front cross member 20 in the vehicle width direction, the recessed groove 26 being recessed downward for approximately half a length of the erected section 24 in the vehicle up-down direction. Here, a lower surface of the recessed groove 26 is joined to a convex portion of the front floor panel 4 that is formed in a corrugated shape along the vehicle front-rear direction.

It is configured that a width in the vehicle front-rear direction of the recessed groove 26 in the crossing section 21 is greater than a width in the vehicle front-rear direction of the recessed groove 26 in another portion such as the member body 22. More specifically, the central portion of the crossing section 21 is formed in a hexagonal shape in the plan view in which the groove width of the recessed groove 26 is greater than that in the other portion such as the member body 22 (see FIG. 2). Then, in a central portion of the recessed groove 26 in the crossing section 21, a cross member through hole 261 that is inserted through the through hole 53 and penetrates in the vehicle up-down direction (see FIGS. 5 and 6).

As illustrated in FIG. 4, the thus-configured front cross member 20 is formed with a pair of left and right ridgeline sections 20a in a corner portion between the erected section 24 and the coupling section 25 and a corner portion of the recessed groove 26 in the coupling section 25, the pair of left and right ridgeline sections 20a extending in the vehicle width direction at predetermined intervals in the vehicle front-rear direction.

Then, the front cross member 20 and the side sill 3 are coupled to each other via the front outer seat bracket 221 such that the ridgeline section 20a, which is formed in the corner portion between the erected section 24 and the coupling section 25, and the ridgeline section 3a, which is set to align the positions of the upper surface of the side sill 3 and the upper surface of the coupling section 25 in the vehicle up-down direction, in the side sill 3 continue via the ridgeline section 221a of the front outer seat bracket 221 (see FIG. 3).

Here, similar to the ridgeline section 3a, which is formed in the corner portion of the upper surface of the side sill 3 and extends in the vehicle front-rear direction, in the side sill 3, rigidity of the ridgeline section 20a, which is formed in the front cross member 20 and extends in the vehicle width direction, in the front cross member 20 is higher than that of other portions (flat portions) in the respective member.

The intermediate cross member 30 that is arranged on the vehicle rear side of the front cross member 20 has substantially the same configuration as the front cross member 20. More specifically, as illustrated in FIGS. 2, 3, and 4, the intermediate cross member 30 includes a crossing section 31 in a central portion in the vehicle width direction and a pair of left and right member bodies 32, the crossing section 31 being provided to extend in the vehicle width direction across the tunnel section 5, and the pair of left and right member bodies 32, each of which extends in the vehicle width direction between an outer end portion of the crossing section 31 in the vehicle width direction and the respective side sill 3.

The crossing section 31 has substantially the same configuration as the crossing section 21 except that the front inner seat bracket 211 is not provided. Thus, a detailed description thereon will not be made. The member body 32 has substantially the same configuration as the member body 22 except that a pair of gussets 321 are provided instead of the pair of the front outer seat brackets 221.

The gusset 321 each has a substantially box shape in which an outer side in the vehicle width direction and the vehicle lower side are opened, and a vertical cross-sectional shape along the vehicle width direction has a closed cross section that is formed by the front floor panel 4, the tunnel section 5, and the intermediate cross member 30. The thus-configured gussets 321 are fixed to the pairs of left and right side sills 3 and the member bodies 32 when being joined by welding such as spot welding. The gussets 321 each have a ridgeline section 321a in an upper portion thereof.

More specifically, an upper surface of the gusset 321 on the vehicle outer side is joined to the upper surface of the side sill 3 by welding such as spot welding, and an upper surface of the gusset 321 on the vehicle inner side is joined to a coupling section 35, which will be described below and corresponds to the coupling section 25, by welding such as spot welding.

Similar to the front cross member 20, in a vertical cross section along the vehicle front-rear direction, such an intermediate cross member 30 is formed to have a substantially M-shaped cross section. More specifically, the intermediate cross member 30 includes a flange section 33, an erected section 34, and the coupling section 35, and, similar to the recessed groove 26, a recessed groove 36 that has a cross member through hole 361 is provided to extend in the vehicle width direction in a central portion of the coupling section 35 in the vehicle front-rear direction (see FIGS. 4, 5, and 6).

Here, since the flange section 33, the erected section 34, the coupling section 35, the recessed groove 36, and the cross member through hole 361 have substantially the same configurations as the flange section 23, the erected section 24, the coupling section 25, the recessed groove 26, and the cross member through hole 261, respectively, a detailed description thereon will not be made. In addition, similar to the front cross member 20, the intermediate cross member 30 is formed with a pair of left and right ridgeline sections 30a in a corner portion between the erected section 34 and the coupling section 35 and a corner portion of the recessed groove 36 in the coupling section 35, the pair of left and right ridgeline sections 30a extending in the vehicle width direction at predetermined intervals in the vehicle front-rear direction.

As described above, the positions of the upper surface of the coupling section 35 and the upper surface of the side sill 3 are set to be aligned in the vehicle up-down direction, and the gusset 321 is joined thereto. In this way, the intermediate cross member 30 and the side sill 3 are coupled to each other via the gusset 321 such that the ridgeline section 30a, which is formed in the corner portion between the erected section 34 and the coupling section 35, and the ridgeline section 3a, which is set to align the positions of the upper surfaces in the vehicle up-down direction, in the side sill 3 continue via the ridgeline section 321a of the gusset 321 (see FIGS. 5 and 6).

The rear cross member 40 that is arranged on the vehicle rear side of the intermediate cross member 30 has substantially the same configuration as the front cross member 20. More specifically, as illustrated in FIGS. 2, 3, and 4, the rear cross member 40 is provided to extend in the vehicle width direction across the tunnel section 5, and includes: in a central portion in the vehicle width direction, a crossing section 41 provided; and a pair of left and right member bodies 42, each of which extends in the vehicle width direction between an outer end portion of the crossing section 41 in the vehicle width direction and the respective side sill 3.

The crossing section 41 has substantially the same configuration as the crossing section 21, and at both end portions of the crossing section 41 in the vehicle width direction, a rear inner seat bracket 411 for attaching the front seat (not illustrated) is provided in a manner to extend across a boundary portion with the respective member body 42.

The rear inner seat bracket 411 has a substantially box shape in which an outer side in the vehicle width direction and the vehicle lower side are opened, and a vertical cross-sectional shape along the vehicle width direction has a closed cross section that is formed by the front floor panel 4, the tunnel section 5, and the rear cross member 40. In addition, the rear inner seat bracket 411 has, on an upper end surface, a rear inner attachment hole 412 for attaching a vehicle front side of the front seat. Here, the rear inner seat bracket 411 and the tunnel section 5 are fixed to each other when being joined by welding such as spot welding.

The member bodies 42 have substantially the same configurations as the member bodies 22, and are joined to the pair of left and right side sills 3 by rear outer seat brackets 421 that are provided in both end portions in the vehicle width direction.

The rear outer seat brackets 421 and the rear inner seat bracket 411 have substantially bilaterally symmetrical shapes. More specifically, the rear outer seat bracket 421 has a substantially box shape in which the outer side in the vehicle width direction and the vehicle lower side are opened, and a vertical cross-sectional shape along the vehicle front-rear direction has a closed cross section that is formed by the front floor panel 4, the tunnel section 5, and the rear cross member 40. The thus-configured rear outer seat brackets 421 are fixed to the pairs of left and right side sills 3 and member bodies 42 when being joined by welding such as spot welding. The rear outer seat bracket 421 has a ridgeline section 421a in an upper portion.

More specifically, an upper surface on the vehicle outer side of the rear outer seat bracket 421 is joined to the upper surface of the side sill 3 by welding such as spot welding, and an upper surface on the vehicle inner side of the rear outer seat bracket 421 is joined to a coupling section 45, which will be described below, by welding such as spot welding. Here, the rear outer seat bracket 421 has, on an upper end surface, a rear outer attachment hole 422 for attaching the vehicle front side of the front seat.

Similar to the front cross member 20, in the vertical cross section along the vehicle front-rear direction, such a rear cross member 40 is formed to have a substantially M-shaped cross section (see FIG. 4). More specifically, the rear cross member 40 includes a flange section 43, an erected section 44, and the coupling section 45, and, similar to the recessed groove 26, a recessed groove 46 having a cross member through hole 461 is provided to extend in the vehicle width direction in a central portion of the coupling section 45 in the vehicle front-rear direction.

Here, since the flange section 43, the erected section 44, the coupling section 45, the recessed groove 46, and the cross member through hole 461 have substantially the same configurations as the flange section 23, the erected section 24, the coupling section 25, the recessed groove 26, and the cross member through hole 261, respectively, a detailed description thereon will not be made. In addition, similar to the front cross member 20, the rear cross member 40 is formed with a pair of left and right ridgeline sections 40a in a corner portion between the erected section 44 and the coupling section 45 and a corner portion of the recessed groove 46 in the coupling section 45, the pair of left and right ridgeline sections 40a extending in the vehicle width direction at predetermined intervals in the vehicle front-rear direction (see FIG. 4).

As described above, the coupling section 45 and the side sill 3 are set such that the positions of the upper surfaces thereof are aligned in the vehicle up-down direction, and the rear outer seat bracket 421 is joined to each thereof.

In this way, the rear cross member 40 and the side sill 3 are coupled to each other via the rear outer seat bracket 421 such that the ridgeline section 40a, which is formed in the corner portion between the erected section 44 and the coupling section 45, and the ridgeline section 3a, which is set to align the positions of the upper surfaces in the vehicle up-down direction, in the side sill 3 continue via the ridgeline section 421a of the rear outer seat bracket 421.

As illustrated in FIG. 4, the thus-configured front cross member 20, intermediate cross member 30, and rear cross member 40 are fixed to each other. More specifically, a front flange section 33a, which is provided on the vehicle front side, of the flange sections 33 in the vehicle front-rear direction of the intermediate cross member 30 is arranged such that the rear flange section 23b, which is provided on the vehicle rear side of the front cross member 20, is arranged on top thereof, and is joined to the front floor panel 4. In addition, a rear flange section 33b, which is provided on the vehicle rear side, of the flange sections 33 in the vehicle front-rear direction of the intermediate cross member 30 is arranged on a vehicle upper side of a front flange section 43a, which is provided on the vehicle front side of the rear cross member 40, and is joined to the upper surface of the front floor panel 4 via the front flange section 43a.

Here, the vehicle front side of the front seat can be attached to the front inner seat bracket 211 and the front outer seat bracket 221, which are provided on the front cross member 20, and the vehicle rear side of the front seat can be attached to the rear inner seat bracket 411 and the rear outer seat bracket 421, which are provided on the rear cross member 40. That is, in the vehicle front-rear direction, the intermediate cross member 30, which is arranged between the front cross member 20 and the rear cross member 40, is arranged on the vehicle lower side of the front seat.

The battery unit 7, which is arranged below the front floor panel 4, is a substantially rectangular structure in the plan view, and includes: battery modules 71 that are arranged side by side in the vehicle width direction; and a casing 72 that accommodates and holds the battery modules 71 therein (see FIGS. 1, 4, and 5).

The battery module 71 is a lithium-ion battery in which plural battery cells are electrically connected, for example, and is formed in a substantially rectangular shape that is long in the vehicle front-rear direction in the plan view. As illustrated in FIGS. 5 and 6, the casing 72 is formed in a substantially annular shape that serves as a frame body of the battery unit 7 and has the substantially rectangular shape in the plan view, and is joined to the highly rigid portion of the body via plural coupling members 80. More specifically, the casing 72 includes a battery frame 73, a bottom plate section 74 that closes an opening on the vehicle lower side of the battery frame 73; and a top plate section 75 that closes an opening on the vehicle upper side of the battery frame 73. Here, the highly rigid portions of the body include the side sills 3, a rear cross member that couples rear side frames (not illustrated) in the vehicle width direction, and a torque box that couples the front portions of the side sills 3 and the front side frame.

The battery frame 73 is a highly rigid frame body that has a substantially rectangular shape in the plan view, and is configured to be able to fixedly fasten the accommodated battery module 71. In addition, the battery frame 73 is fixedly fastened to the highly rigid portion including a frame member, such as the side sill 3, that forms the body frame structure.

As illustrated in FIG. 6, a central portion of the battery frame 73 in the vehicle width direction is provided with: a front-rear direction frame 76 that couples frames on the vehicle front side and the vehicle rear side in the battery frame 73, which has a rectangular shape in the plan view, in the vehicle front-rear direction; an intermediate frame 77 that is arranged on the vehicle upper side of the front-rear direction frame 76; and a support section 78 that supports the intermediate frame 77.

As illustrated in FIGS. 6 and 7, in a transverse cross section along the vehicle width direction, the front-rear direction frame 76 is formed to have a substantially hat-shaped cross section that protrudes upward in a substantially rectangular shape in the vehicle, and couples the frames on the vehicle front side and the vehicle rear side in the battery frame 73, which has the substantially rectangular shape in the plan view, in the vehicle front-rear direction. In addition, the front-rear direction frame 76 has a flange (not denoted by a reference sign) that extends in the vehicle width direction and is provided from a front end to a rear end thereof in the vehicle front-rear direction, and joins the flange to the bottom plate section 74 by welding such as spot welding. In this way, the front-rear direction frame 76 improves rigidity of the battery frame 73 and rigidity of a central portion of the bottom plate section 74 in the vehicle width direction.

As illustrated in FIGS. 6 and 7, in the transverse cross section along the vehicle front-rear direction, the intermediate frame 77 has a concave cross-sectional shape that is opened upward, and is arranged on the vehicle upper side at a predetermined interval from an upper surface of the front-rear direction frame 76. In addition, in a central portion of the intermediate frame 77 in the vehicle width direction, intermediate through holes 771, each of which penetrates in the up-down direction and has a circular shape in the plan view, are provided at predetermined intervals in the vehicle front-rear direction in a manner to be arranged on the vehicle lower side of and oppose the through holes 53 provided in the tunnel upper portion 52.

As illustrated in FIG. 6, the support section 78 is a support member that supports the intermediate frame 77 in a manner to be provided on the vehicle upper side of the upper surface of the front-rear direction frame 76 at predetermined intervals. More specifically, a lower end portion of the support section 78 is coupled to the front-rear direction frame 76, and an upper end portion of the support section 78 is coupled to an outer portion in the vehicle width direction of a lower surface of the intermediate frame 77. In this way, on the vehicle upper side of the front-rear direction frame 76, the support section 78 supports the intermediate frame 77 at the predetermined interval from the front-rear direction frame 76. Here, the height of the support section 78 is set such that the distance between the upper surface of the intermediate frame 77 and a lower surface of the top plate section 75 in the vehicle up-down direction is equal to the distance between an upper surface of the top plate section 75 and a lower surface of the tunnel upper portion 52 in the vehicle up-down direction.

As illustrated in FIG. 5, the bottom plate section 74 is a plate member that has a thickness in the up-down direction, and is configured to be able to be fixedly fastened to the battery frame 73. As illustrated in FIGS. 5 and 6, the top plate section 75 is a plate member that has a thickness in the up-down direction, and is configured to be able to be fixedly fastened to the upper surface of the battery frame 73. In addition, as illustrated in FIG. 7, in the top plate section 75, plural top plate through holes 751, each of which penetrates in the vehicle up-down direction and has a circular shape in the plan view, are provided in the vehicle front-rear direction in a manner to be arranged to oppose the through holes 53 and the intermediate through holes 771. Here, each of the top plate through holes 751 has substantially the same shape as the respective through hole 53 and the respective intermediate through hole 771 in the plan view. The coupling member 80 is arranged between the thus-configured top plate through hole 751 and the intermediate through hole 771 and between the top plate through hole 751 and the through hole 53.

As illustrated in FIGS. 5 and 6, the coupling member 80 couples the tunnel section 5 and the battery unit 7 via a fastening bolt V. More specifically, as illustrated in FIG. 6, the coupling member 80 is integrally formed by a shaft section 81 that extends in an axial direction along the vehicle up-down direction and a body section 82 that extends to one side in the axial direction of the shaft section 81.

The shaft section 81 is formed in a substantially columnar shape that has a thread, to which a nut N can be screwed, on an outer circumferential surface (see FIGS. 6 and 7). Here, an axial length of the shaft section 81 is shorter than the distance between the front-rear direction frame 76 and the intermediate frame 77 in the vehicle up-down direction.

As illustrated in FIGS. 6 and 7, the body section 82 is formed in a length that is equal to the distance between the upper surface of the intermediate frame 77 and the lower surface of the top plate section 75. In addition, as illustrated in FIG. 6, the body section 82 is formed in the substantially columnar shape that has a larger diameter than the shaft section 81 and extends from the shaft section 81. When the shaft section 81 is inserted through the intermediate through hole 771, a lower end surface of the thus-configured body section 82 abuts the upper surface of the intermediate frame 77, and an upper end surface thereof abuts the lower surface of the top plate section 75.

In addition, as illustrated in FIG. 6, the body section 82 of the coupling member 80 is formed with a screw hole 821 that is recessed from the upper end surface along the axial direction. More specifically, the screw hole 821 of the body section 82 has substantially the same structure as the screw hole for the nut N, and is formed from the upper end surface of the body section 82 to the vicinity of the substantial center in the axial direction of the body section 82. The shaft section 81 of the coupling member 80 as a separate body can be screwed into the thus-configured screw hole 821 from the vehicle upper side. Here, the fastening bolt V, which fastens the coupling member 80 from the vehicle upper side, is a hexagonal bolt that has the same diameter as the shaft section 81 and is screwed to the screw hole 821, which is provided at the upper end of the body section 82 in the coupling member 80 (see FIG. 6).

As illustrated in FIGS. 5, 6, and 7, the thus-configured coupling member 80 couples the tunnel section 5, the floor cross member 6, and the battery unit 7. More specifically, the nut N is fastened to the shaft section 81, which is inserted through the intermediate through hole 771, in the coupling member 80 arranged between the top plate section 75 and the intermediate frame 77, and is screwed onto the shaft section 81 of the other coupling member 80, which is inserted through the top plate through hole 751 from the vehicle upper side of the top plate section 75. In this way, the coupling member 80, which is arranged between the top plate section 75 and the intermediate frame 77, and the top plate section 75 are fixed.

In addition, the coupling member 80, in which the shaft section 81 inserted through the top plate through hole 751 is screwed into the screw hole 821 of the coupling member 80 arranged between the top plate section 75 and the intermediate frame 77, is arranged between the top plate section 75 and the tunnel upper portion 52 in a state of abutting the upper surface of the top plate section 75 and the lower surface of the tunnel upper portion 52 (see FIGS. 5, 6, and 7). Then, from the cabin inner side, the fastening bolt V, which is inserted through the cross member through holes 261, 361, 461 respectively provided to the crossing sections 21, 31, 41 in the front cross member 20, the intermediate cross member 30, and the rear cross member 40 extending across the tunnel section 5 and the through hole 53 provided to the tunnel upper portion 52 of the tunnel section 5, is fastened to the coupling member 80 arranged between the top plate section 75 and the tunnel upper portion 52 (see FIGS. 5, 6, and 7).

Just as described, in the lower body structure of the vehicle 1, the coupling member 80, which is arranged between the top plate section 75 and the intermediate frame 77, and the coupling member 80, which is arranged between the top plate section 75 and the tunnel upper portion 52, couple the tunnel section 5, the floor cross member 6, and the battery unit 7 by fastening the fastening bolt V.

In this way, as illustrated in FIG. 7, in the lower body structure of the vehicle 1, the plural coupling members 80 are arranged in the vehicle front-rear direction between the top plate section 75 and the tunnel upper portion 52 in a manner to correspond to the position of each of the through holes 53, which are provided at the predetermined intervals in the vehicle front-rear direction. In the state where the upper end surface of the coupling member 80 abuts the lower surface of the tunnel upper portion 52 and the lower end surface of the coupling member 80 abuts the upper surface of the top plate section 75, these coupling members 80 couple the battery unit 7, which accommodates and holds the battery modules 71 therein, in the casing 72 to the tunnel section 5 and the floor cross member 6.

In addition, the battery unit 7, which is coupled to the pair of left and right side sills 3 as body frame members of the vehicle 1, fixedly couples each of the front cross member 20, the intermediate cross member 30, and the rear cross member 40, which are fixed to each other and each couple the pair of left and right side sills 3 across the tunnel section 5, to the tunnel section 5 in the tunnel upper portion 52 of the tunnel section 5 as the central portion in the vehicle width direction. As a result, in the lower body structure of the vehicle 1, body rigidity of the vehicle 1 is improved.

As described above, the lower body structure of the vehicle 1 includes: the pair of left and right side sills 3 that extend in the vehicle front-rear direction on both lateral ends of the front floor panel 4 in the vehicle width direction; and the plural floor cross members 6, each of which couples the pair of left and right side sills 3 in the vehicle width direction and is fixed to the upper surface of the front floor panel 4. Then, the floor cross member 6 has: the front cross member 20 that is provided on the vehicle front side; the rear cross member 40 that is provided on the vehicle rear side at the predetermined interval from the front cross member 20; and the intermediate cross member 30 that is provided between the front cross member 20 and the rear cross member 40 in the vehicle front-rear direction and is fixed to each of the front cross member 20 and the rear cross member 40.

In this way, the lower body structure of the vehicle 1 can efficiently transmit a side collision load from the side sill 3 on one side in the vehicle width direction to the other side sill 3. More specifically, the front cross member 20, the rear cross member 40, and the intermediate cross member 30, each of which is fixed to the upper surface of the front floor panel 4, are provided to couple the pair of left and right side sills 3, which extend in the vehicle front-rear direction on both lateral ends of the front floor panel 4 in the vehicle width direction, in the vehicle width direction. Then, the intermediate cross member 30 is fixed to each of the front cross member 20 and the rear cross member 40. Accordingly, in cooperation with the front floor panel 4, the front cross member 20, the intermediate cross member 30, and the rear cross member 40, which are fixed to each other, can improve the rigidity of the body against the side collision load as a collision load from the vehicle lateral side. Therefore, in the lower body structure of the vehicle 1, the side collision load, which is generated when a narrow collision object such as a utility pole collides with the vehicle lateral side, can efficiently be transmitted from the one side sill 3 to the other side sill 3.

As described above, in the lower body structure of the vehicle 1, the front cross member 20, the rear cross member 40, the intermediate cross member 30, which is fixed to each of the front cross member 20 and the rear cross member 40, and the front floor panel 4 can cooperatively improve the rigidity of the body and efficiently transmit the side collision load from the one side sill 3 to the other side sill 3 in the vehicle width direction. Therefore, the lower body structure of the vehicle 1 can suppress deformation of the side sill 3, the floor cross member 6 (the front cross member 20, the intermediate cross member 30, and the rear cross member 40), the front floor panel 4, and the like caused by the side collision load, which is generated when the narrow collision object collides with the vehicle lateral side.

In addition, the front cross member 20 is provided with the front inner seat bracket 211 and the front outer seat bracket 221 for attaching the front side of the front seat in the vehicle 1, and the rear cross member 40 is provided with the rear inner seat bracket 411 and the rear outer seat bracket 421 for attaching the rear side of the front seat.

In this way, in the lower body structure of the vehicle 1, at the position near a position of a center of gravity in the vehicle 1, the side collision load can efficiently be transmitted from the one side sill 3 to the other side sill 3. More specifically, in general, the position of the center of gravity in the vehicle 1 is frequently set at a position near the front seat in the vehicle front-rear direction. Between the front cross member 20 and the rear cross member 40, the intermediate cross member 30, which is fixed thereto, is arranged. The front cross member 20 is provided with the front inner seat bracket 211 and the front outer seat bracket 221, each of which attaches the front side of the front seat at the position near the position of the center of gravity in the vehicle 1 in the vehicle front-rear direction as described above. The rear cross member 40 is provided with the rear inner seat bracket 411 and the rear outer seat bracket 421 for attaching the rear side of the front seat. In this way, the lower body structure of the vehicle 1 can improve the rigidity of the body at the position near the position of the center of gravity in the vehicle 1. Thus, at the position near the position of the center of gravity in the vehicle 1, it is possible to efficiently transmit the side collision load from the one side sill 3 to the other side sill 3.

More specifically, in the case where the narrow collision object collides with the vehicle lateral side, which deviates from the position of the center of gravity of the vehicle 1, the body rotates about the center of gravity of the vehicle 1 as a rotation center. Thus, the side collision load can be dispersed. Meanwhile, in the case where the narrow collision object collides with the vehicle lateral side toward the position of the center of gravity of the vehicle 1, the side collision load is concentrically applied to the body without being dispersed.

In the lower body structure of the vehicle 1, as described above, between the front cross member 20 and the rear cross member 40, the intermediate cross member 30 is fixed to the front cross member 20 and the rear cross member 40 and is also fixed to the front floor panel 4. The front cross member 20 is provided with the front inner seat bracket 211 and the front outer seat bracket 221 for attaching the front side of the front seat. The rear cross member 40 is provided with the rear inner seat bracket 411 and the rear outer seat bracket 421 for attaching the rear side of the front seat. Thus, at the position near the position of the center of gravity in the vehicle 1, the intermediate cross member 30, which is arranged below the front seat, can improve rigidity. In this way, even when the narrow collision object collides with the vehicle lateral side toward the position of the center of gravity of the vehicle 1, the side collision load, which is concentrically applied to the body, can efficiently be transmitted from the one side sill 3 to the other side sill 3.

In addition, in the lower body structure of the vehicle 1, between the front cross member 20 and the rear cross member 40 in the vehicle front-rear direction, the intermediate cross member 30, which is fixed thereto, is arranged on the lower side of the front seat. Thus, it is possible to secure sufficient space in a foot portion of the front seat even when the intermediate cross member 30 is provided.

Furthermore, the floor cross member 6 (the front cross member 20, the intermediate cross member 30, and the rear cross member 40) is formed to have the substantially M-shaped cross section that extends in the vehicle width direction. Thus, compared to a case where the cross member is formed to have the hat-shaped cross section, it is possible to improve the rigidity of each member of the floor cross member 6 (the front cross member 20, the intermediate cross member 30, and the rear cross member 40). Thus, the lower body structure of the vehicle 1 can efficiently transmit the side collision load from the one side sill 3 to the other side sill 3.

The tunnel section 5 that protrudes upward is formed at the central position of the front floor panel 4 in the vehicle width direction. The floor cross member 6 (the front cross member 20, the intermediate cross member 30, and the rear cross member 40) couples the pair of left and right side sills 3 in the vehicle width direction across the tunnel section 5.

In the thus-configured lower body structure of the vehicle 1, the floor cross member 6 (the front cross member 20, the intermediate cross member 30, and the rear cross member 40), which is provided across the tunnel section 5 extending in the vehicle front-rear direction at the central position in the vehicle width direction, is coupled to the pair of left and right side sills 3 in the vehicle width direction. Accordingly, in the lower body structure of the vehicle 1, compared to a pair of the floor cross members 6 (the front cross member 20, the intermediate cross member 30, and the rear cross member 40), which couple the pair of left and right side sills 3 across the tunnel section 5, the side collision load can reliably be transmitted from the one side sill 3 to the other side sill 3.

Furthermore, the tunnel section 5 has the side wall portions 51 that oppose each other in the vehicle width direction, and the floor cross member 6 (the front cross member 20, the intermediate cross member 30, and the rear cross member 40) includes the front flange sections 23a, 33a, 43a, each of which extends forward in the vehicle, and the rear flange sections 23b, 33b, 43b, each of which extends rearward in the vehicle. Then, the front flange sections 23a, 33a, 43a and the rear flange sections 23b, 33b, 43b are joined to the side wall portions 51.

In this way, the floor cross member 6 (the front cross member 20, the intermediate cross member 30, and the rear cross member 40) can form the closed cross section in the side wall portion 51 of the tunnel section 5. Thus, it is possible to improve the rigidity of the tunnel section 5 and improve the rigidity of the floor cross member 6 (the front cross member 20, the intermediate cross member 30, and the rear cross member 40) that extends across the tunnel section 5. Therefore, the lower body structure of the vehicle 1 can efficiently transmit the side collision load from the one side sill 3 to the other side sill 3 across the tunnel section 5 while suppressing the deformation of the tunnel section 5.

The rear flange section 23b of the front cross member 20 is fixed in the manner to be superposed on the front flange section 33a of the intermediate cross member 30, and the rear flange section 33b of the intermediate cross member 30 is fixed in the manner to be superposed on the front flange section 43a of the rear cross member 40. Accordingly, the front cross member 20, the intermediate cross member 30, and the rear cross member 40 can easily be attached to the front floor panel 4. Therefore, it is possible to improve the efficiency of the fixing work to fix the front cross member 20, the intermediate cross member 30, and the rear cross member 40 to the front floor panel 4.

In the lower body structure of the vehicle 1, the front cross member 20 and the rear cross member 40 are respectively provided with the front inner seat bracket 211, the front outer seat bracket 221, the rear inner seat bracket 411, and the rear outer seat bracket 421 for attaching the front seat in the vehicle 1. Thus, it is possible to suppress the front seat from being displaced downward in the vehicle.

More specifically, the lower body structure of the vehicle 1 can support the front cross member 20 by the intermediate cross member 30, and can support the intermediate cross member 30 by the rear cross member 40. Accordingly, it is possible to restrict the downward displacement of the floor cross member 6 (the front cross member 20, the intermediate cross member 30, and the rear cross member 40), which is associated with upward displacement of the tunnel section 5 by the side collision load. Therefore, in the case where the front cross member 20 and the rear cross member 40 are respectively provided with the front inner seat bracket 211, the front outer seat bracket 221, the rear inner seat bracket 411, and the rear outer seat bracket 421 for attaching the front seat in the vehicle 1, the lower body structure of the vehicle 1 can suppress the downward displacement of the front seat.

The side sill 3 and the floor cross member 6 (the front cross member 20, the intermediate cross member 30, and the rear cross member 40) are joined to each other in the manner to align the positions of the upper surface of the side sill 3 and the upper surface of the floor cross member 6 (the front cross member 20, the intermediate cross member 30, and the rear cross member 40) in the vehicle up-down direction.

As a result, the ridgeline section 3a and the ridgeline sections 20a, 30a, 40a, the rigidity of which is higher than that of the other portions in the side sill 3 and the floor cross member 6 (the front cross member 20, the intermediate cross member 30, and the rear cross member 40) have the extending directions that are substantially orthogonal to each other in the plan view but are located at substantially the same positions in the vehicle up-down direction. That is, the ridgeline sections 20a, 30a, 40a of the floor cross member 6 (the front cross member 20, the intermediate cross member 30, and the rear cross member 40) continue to the ridgeline section 3a of the side sill 3. Therefore, the lower body structure of the vehicle 1 can efficiently transmit the side collision load from the one side sill 3 to the other side sill 3.

Furthermore, the battery unit 7 is provided below the front floor panel 4. The coupling member 80 is provided to be fastened to the fastening bolt V, which is inserted from the upper surface of the floor cross member 6 (the front cross member 20, the intermediate cross member 30, and the rear cross member 40) superposed on the tunnel section 5, and couples the floor cross member 6 (the front cross member 20, the intermediate cross member 30, and the rear cross member 40) to the battery unit 7.

As a result, in the central portion in the vehicle width direction, the upward displacement of the floor cross member 6 (the front cross member 20, the intermediate cross member 30, and the rear cross member 40) and the tunnel section 5 by the side collision load can be suppressed by the battery unit 7, which is coupled thereto via the fastening bolt V and the coupling member 80. Therefore, the lower body structure of the vehicle 1 can reliably transmit the side collision load from the one side sill 3 to the other side sill 3.

The recessed grooves 26, 36, 46, each of which is recessed downward and extends in the vehicle width direction, are provided to the upper surface of the floor cross member 6 (the front cross member 20, the intermediate cross member 30, and the rear cross member 40). The lengths of the recessed grooves 26, 36, 46 in the vehicle front-rear direction in the tunnel section 5 are longer than the lengths of the recessed grooves 26, 36, 46 in the other portions.

As a result, it is possible to secure a seat surface for fixing the floor cross member 6 (the front cross member 20, the intermediate cross member 30, and the rear cross member 40) and the battery unit 7 and to improve the rigidity of the floor cross member 6 (the front cross member 20, the intermediate cross member 30, and the rear cross member 40). Therefore, the lower body structure of the vehicle 1 can reliably fix the floor cross member 6 (the front cross member 20, the intermediate cross member 30, and the rear cross member 40) to the battery unit 7, and can further suppress the upward displacement of the floor cross member 6 (the front cross member 20, the intermediate cross member 30, and the rear cross member 40).

In correspondence between the configuration in the disclosure and the above-described embodiment, the floor panel in the disclosure corresponds to the front floor panel 4 in the embodiment. Hereinafter, similarly, the cross member corresponds to the floor cross member 6, the first cross member corresponds to the front cross member 20, the second cross member corresponds to the rear cross member 40, the third cross member corresponds to the intermediate cross member 30, the front attachment section corresponds to the front inner seat bracket 211 and the front outer seat bracket 221, the rear attachment section corresponds to the rear inner seat bracket 411 and the rear outer seat bracket 421, the front flange section corresponds to the front flange sections 23a, 33a, 43a, the rear flange section corresponds to the rear flange sections 23b, 33b, 43b, the fastening member corresponds to the fastening bolt V, and the coupling section corresponds to the coupling member 80. However, the disclosure is not limited only to the configuration in the above-described embodiment, and many embodiments can be obtained.

For example, the floor cross member 6 (the front cross member 20, the intermediate cross member 30, and the rear cross member 40) has the closed cross-sectional shape that forms the closed cross section with the front floor panel 4. However, the disclosure is not limited thereto, and the floor cross member 6 (the front cross member 20, the intermediate cross member 30, and the rear cross member 40) may join the closed cross-sectional shape such as a cylindrical body to the front floor panel 4.

The above-described side sill 3 and the floor cross member 6 (the front cross member 20, the intermediate cross member 30, and the rear cross member 40) indirectly join the upper surface of the side sill 3 and the upper surface of the floor cross member 6 (the front cross member 20, the intermediate cross member 30, and the rear cross member 40) at substantially the same height via the front outer seat brackets 221, the gussets 321, and the rear outer seat brackets 421. However, the configuration is not limited thereto as long as it is configured that the ridgeline sections 3a and the ridgeline sections 20a, 30a, 40a continue.

For example, the side sill 3 and the floor cross member 6 (the front cross member 20, the intermediate cross member 30, and the rear cross member 40) may be joined to each other in the manner to align the upper surface of the side sill 3 and the upper surface of the floor cross member 6 (the front cross member 20, the intermediate cross member 30, and the rear cross member 40) in the vehicle width direction. Alternatively, the floor cross member 6 (the front cross member 20, the intermediate cross member 30, and the rear cross member 40) may be arranged such that the upper surface of the floor cross member 6 (the front cross member 20, the intermediate cross member 30, and the rear cross member 40) partially overlaps the upper surface of the side sill 3, and the overlapping portions may directly or indirectly join the side sill 3 and the floor cross member 6.

Further alternatively, in the case where the upper surface of the side sill 3 is an inclined surface that is inclined in the vehicle up-down direction with respect to the vehicle width direction, in the vehicle up-down direction, they may directly or indirectly be joined such that the upper surface of the floor cross member 6 (the front cross member 20, the intermediate cross member 30, and the rear cross member 40) is arranged within a range from an upper end position to a lower end position of the inclined upper surface of the side sill 3.

What is claimed is:

1. A vehicle lower body structure comprising:
a pair of left and right side sills that extend in a vehicle front-rear direction at opposing lateral ends of a floor panel in a vehicle width direction; and
plural cross members, each of which couples the pair of left and right side sills in the vehicle width direction and is fixed to an upper surface of the floor panel, wherein
the cross members include: a first cross member located on a vehicle front side; a second cross member located on a vehicle rear side at a predetermined interval from the first cross member; and a third cross member located between the first cross member and the second cross member in the vehicle front-rear direction and is fixed to each of the first cross member and the second cross member.

2. The vehicle lower body structure according to claim 1, wherein
the first cross member has a front attachment section, to which a front side of a front seat in a vehicle is attached, and the second cross member has a rear attachment section, to which a rear side of the front seat is attached.

3. The vehicle lower body structure according to claim 1 or 2, wherein
the cross members each have a substantially M-shaped cross section that extends in the vehicle width direction.

4. The vehicle lower body structure according to claim 1 or 2, wherein
a tunnel section that protrudes upward is formed in a central position of the floor panel in the vehicle width direction, and the cross members each couple the pair of left and right side sills in the vehicle width direction across the tunnel section.

5. The vehicle lower body structure according to claim 4, wherein
the tunnel section has a side wall portion opposed to the vehicle width direction, the cross members include a front flange section extending forward in the vehicle and a rear flange section extending rearward in the vehicle, and the front flange section and the rear flange section are joined to the side wall portion.

6. The vehicle lower body structure according to claim 5, wherein
the rear flange section of the first cross member is fixedly superimposed on the front flange section of the third cross member, and the rear flange section of the third cross member is fixedly superimposed on the front flange section of the second cross member.

7. The vehicle lower body structure according to claim 1 or 2, wherein
the side sill and the cross members are joined to each other such that positions of an upper surface of the side sill and an upper surface of the cross members are aligned in the vehicle up-down direction.

8. The vehicle lower body structure according to claim 4, wherein
a battery unit is located below the floor panel, and a coupling section couples the cross members and the battery unit to each other by a fastening member inserted from an upper surface of the cross member superimposed on the tunnel section.

9. The vehicle lower body structure according to claim 8, wherein
the upper surface of the cross members has a recessed groove recessed downward and extending in the vehicle width direction, and a length of the recessed groove in the tunnel section in the vehicle front-rear direction is longer than a length of the recessed groove in the vehicle front-rear direction in another portion.
